(19) United States
(12) Patent Application Publication
(10) Pub. No.: US 2025/0055123 A1
(43) Pub. Date: Feb. 13, 2025

(54) Multi-Cell Battery Housing With Auxiliary Vent Channels

(71) Applicant: The Johns Hopkins University, Baltimore, MD (US)

(72) Inventors: Rengaswamy Srinivasan, Ellicott City, MD (US); Plamen A. Demirev, Ellicott City, MD (US); Bliss G. Carkhuff, Laurel, MD (US); Avrami Rakovsky, Baltimore, MD (US); Hicham Alkandry, Olney, MD (US)

(73) Assignee: The Johns Hopkins University, Baltimore, MD (US)

(21) Appl. No.: 18/800,862

(22) Filed: Aug. 12, 2024

Related U.S. Application Data
(60) Provisional application No. 63/519,211, filed on Aug. 11, 2023.

(51) Int. Cl. H01M 50/367; H01M 50/229; H01M 50/244; H01M 50/293; H01M 50/342

(52) U.S. Cl. CPC H01M 50/367; H01M 50/229; H01M 50/244; H01M 50/293; H01M 50/3425

(57) ABSTRACT

A battery housing may include a primary vent channel, auxiliary vent channels, and receptacles for receiving cells. Each receptacle may have sidewalls that operate as barriers to cell venting events occurring in other receptacles, an auxiliary vent channel opening to a respective auxiliary vent channel, and a primary vent channel opening to the primary vent channel. Each primary vent channel opening may be aligned with a position of a vent valve of a cell disposed within a respective receptacle such that internal substances expelled from the vent valve or a rupture at the vent valve in an associated vent direction are directed into the primary vent channel. Each auxiliary vent channel opening is not aligned with a respective primary vent channel opening and a respective position of a vent valve.

### CROSS-REFERENCE TO RELATED APPLICATIONS

This application claims priority to and the benefit of prior-filed, co-pending U.S. Provisional Application No. 63/519,211 filed on Aug. 11, 2023, the entire contents of which are hereby incorporated herein by reference.

### TECHNICAL FIELD

Example embodiments generally relate to battery technology and, in particular, relate to mitigation of the effects of cell failures.

### BACKGROUND

Lithium-ion (Li-ion) cells and batteries of Li-ion cells differ uniquely from other previously-introduced electrochemical devices. The distinctively higher cell voltages, energy and power densities, and longer cycle and shelf lives have made Li-ion batteries an essential component in almost all aspects of current human activity on Earth and in space. Today Li-ion batteries are found in electric vehicles, power grids, power tools, smartphones, drones, surgical tools, and the like. In space, virtually every spacecraft launched since 2003 contains Li-ion batteries as a main energy storage system and the source of electric power. When compared to other sources of energy, such as, for example, gasoline, Li-ion batteries are superior due to the ability to not only release energy but to store energy repeatedly (recharged) for more than one thousand times (cycles), while gasoline stores and subsequently releases energy only once.

While Li-ion batteries have proven to be highly effective by bringing many benefits in a variety of applications, Li-ion, and other lithium-based batteries still have drawbacks. One drawback is that such batteries, particularly batteries having large numbers of cells, require a management system to monitor the cells to ensure proper operation and to detect potential issues with the individual cells. Monitoring the condition of the cells is often necessary because a single cell failure leading to a high-temperature phenomenon known as “thermal runaway” can have a cascading effect spreading to other cells (cell-to-cell propagation of thermal runaway) that leads to battery fire and deflagration. When a cell begins to fail, a thermal runaway condition can occur where the temperature and pressure within the cell increase rapidly. Conventional cells include a pressure sensitive feature or vent valve that allows the internal pressure to be relieved through one or more vents opening in the cell through which gasses can be expelled. Even after such venting event occurs, in some instances, heating of the cell may continue until the remaining material within the cell ultimately ignites and is expelled. A conventional cell may be designed such that the direction that the contents of the cell are expelled is predictable due to a positioning of vent valve. The main purpose of the vent valve, which may be a weakened cap, is to direct the venting substances (e.g., gases, liquids and solids) along a designer-preferred direction, i.e., a vent direction. The ejected substances (known as, in the aggregate, ejecta) carry three forms of energy: thermal, chemical, and mechanical. Whether the contents of the cell are partially or fully expelled, the energy in the ejecta from this first failing cell, i.e., the “trigger” cell, can cause heating of adjacent cells of the battery that may have operated properly prior to such heating. When the adjacent cells are heated to failure, thermal runaway may continue propagating to many or all the cells of a battery leading to a total battery failure. Due to the severe effects caused by a thermal runaway propagation event, innovation in the area of preventing such propagation is highly desired. It is, therefore, at most essential to direct the ejecta away from all the other cells in the battery, allowing them to exit the battery housing quickly, preferably at the same rate as it is exiting the failing trigger cell. Note that the thermal process is a fast process, occurring in a fraction of a second, and the solid matter in the ejecta are capable of fully or partially clogging vents, slowing down the movement of the ejecta, allowing sufficient time for energy-transfer from the ejecta to adjacent cells. This is one reason is why Li-ion batteries in housings with poorly-designed vents continue to experience cell-to-cell propagation of thermal runaway, fire, and deflagration.

### BRIEF SUMMARY

According to some non-limiting, example embodiments, a battery housing is described. The battery housing may include a plurality of vent channels including a primary vent channel and a plurality of auxiliary vent channels. Each auxiliary vent channel may be isolated from the primary vent channel and other auxiliary vent channels. The battery housing may also include a plurality of receptacles. Each receptacle may be configured to receive a cell, and each receptacle may have sidewalls that are configured to operate as barriers to cell venting events occurring in other receptacles. Each receptacle may include an auxiliary vent channel opening to a respective auxiliary vent channel, and each receptacle may include a primary vent channel opening to the primary vent channel. Each primary vent channel opening may be configured to be aligned with a position of a vent valve of a cell disposed within a respective receptacle such that internal substances expelled from the vent valve or a rupture at the vent valve in an associated vent direction are directed into the primary vent channel. Each auxiliary vent channel opening, according to some example embodiments, is not aligned with a respective primary vent channel opening and a respective position of a vent valve.

According to some example embodiments, another battery housing is described. In this regard, the battery housing may include a primary vent channel, a plurality of auxiliary vent channels, and a plurality of receptacles including a first receptacle and a second receptacle, the first receptacle being configured to receive a first cell in a first installed position that aligns a first vent direction defined by a first vent valve of the first cell toward the primary vent channel, the second receptacle being configured to receive a second cell in a second installed position that aligns a second vent direction defined by a second vent valve of the second cell toward the primary vent channel. The first auxiliary vent channel associated with the first receptacle may include a first auxiliary vent channel opening that does not intersect with the first vent direction. A second auxiliary vent channel associated with the second receptacle may include a second auxiliary vent channel opening that does not intersect with the second vent direction.

According to some example embodiments, a method for venting a cell within a battery housing is described. In this regard, the method may include venting internal solids and liquids of a trigger cell disposed in a first receptacle of the battery housing into a primary vent channel in a first vent direction from a vent valve of the trigger cell. The primary vent channel may be shared with other receptacles for cells of the battery housing. Additionally, the method may include venting gases expelled from the trigger cell into an auxiliary vent channel opening of an auxiliary vent channel of the battery housing. The first vent direction, according to some example embodiments, does not intersect with the first auxiliary vent channel opening.

### BRIEF DESCRIPTION OF THE SEVERAL VIEWS OF THE DRAWING(S)

Having thus described some non-limiting, example embodiments in general terms, reference will now be made to the accompanying drawings, which are not necessarily drawn to scale, and wherein:

FIG. 1A illustrates an example cell having a cylindrical shape according to some example embodiments;

FIG. 1B illustrates an example cell having a rectangular prism shape according to some example embodiments;

FIG. 1C illustrates a vent event involving three cells within a housing according to some example embodiments;

FIG. 2A illustrates a perspective top view of an example battery housing according to some example embodiments;

FIG. 2B illustrates a front view of an example battery housing according to some example embodiments;

FIG. 2C illustrates a top view of an example battery housing according to some example embodiments;

FIG. 3A illustrates a cross-section bottom view of an example battery housing taken at line A-A in FIG. 2B according to some example embodiments;

FIG. 3B illustrates a cross-section bottom view of an example battery housing with installed cells taken at line A-A in FIG. 2B according to some example embodiments;

FIG. 3C illustrates a cross-section bottom view of an example battery housing with installed cells taken at line A-A in FIG. 2B with one cell having a venting event according to some example embodiments;

FIG. 3D illustrates a cross-section bottom view of an example battery housing with installed cells taken at line A-A in FIG. 2B with one cell having a venting event and a primary vent channel having a single external opening according to some example embodiments;

FIG. 3E illustrates a cross-section bottom view of an example battery housing with installed cells taken at line A-A in FIG. 2B with one cell having a venting event that causes a blockage of the primary vent channel according to some example embodiments;

FIG. 4A illustrates a cross-section side view of an example battery housing with installed cells taken at line B-B in FIG. 2C with one cell having a venting event according to some example embodiments;

FIG. 4B illustrates a cross-section side view of an example battery housing with installed cells taken at line B-B in FIG. 2C with one cell having a venting event that causes a blockage of the primary vent channel according to some example embodiments;

FIG. 5A illustrates a top view of an example battery housing with linear auxiliary vent channels according to some example embodiments;

FIG. 5B illustrates a top view of an example battery housing with nonlinear auxiliary vent channels according to some example embodiments;

FIG. 6A illustrates a perspective top view of an example battery housing according to some example embodiments;

FIG. 6B illustrates a top view of an example battery housing according to some example embodiments;

FIG. 6C illustrates a front view of an example battery housing according to some example embodiments;

FIG. 6D illustrates a perspective cross-section top view taken at line C-C of FIG. 6C according to some example embodiments;

FIG. 6E illustrates a cross-section bottom view taken at line D-D of FIG. 6C according to some example embodiments;

FIG. 6F illustrates a perspective top view of an example battery housing including a primary vent channel enclosure according to some example embodiments; and

FIG. 7 illustrates a flowchart of an example method for venting a cell of a battery according to some example embodiments.

### DETAILED DESCRIPTION

Some non-limiting, example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Non-limiting, example embodiments described herein operate to limit or prevent the propagation of thermal runaway within a multi-cell battery such as, for example, a battery with a plurality of lithium-ion cells. To do so, according to some example embodiments, a battery housing may include a plurality of vent channels associated with a cell receptacles (or simply referred to as receptacles herein) for receiving and holding a cell (e.g., a battery cell) during operation. The cell receptacles may be operably coupled to the vent channels to support reliable venting of internal cell substances or ejecta when a cell failure occurs. Such reliable venting may avoid the build-up of heat and pressure associated with the cell failure, thereby reducing the risk of affecting the operation of other cells. In addition to reliable venting, according to some example embodiments, the cell receptacles may include receptacle sidewalls that limit interaction between the cells when a cell failure occurs. The receptacle side walls, according to some example embodiments, may operate not only to limit or prevent the spreading of thermal energy, but also limit or eliminate the spread of combustible substances that may be expelled from a failing cell.

According to some example embodiments, the cell receptacles may be positioned adjacent to a primary vent channel. The primary vent channel may be a “shared” vent channel that may provide a venting pathway to more than one cell receptacle. In this regard, the primary vent channel include a primary vent channel opening for each cell receptacle. According to some example embodiments, the cell receptacles may be aligned with a respective opening into the primary vent channel, such that a vent direction for a vent valve of a cell disposed within a cell receptacle will vent into the primary vent channel. In this regard, according to some example embodiments, each cell receptacle may have a primary vent channel opening to the primary vent channel, and each primary vent channel opening may be configured to be aligned with a position of a vent valve of a cell disposed within a respective receptacle such that internal substances expelled from the vent valve or a rupture at the vent valve in an associated vent direction are directed into the primary vent channel. As such, the primary vent channel may include one or more external openings that allow vented substances to escape from the battery housing into an external space to relieve potential pressure increases and heating within the battery housing.

In addition to the shared, primary vent channel, according to some example embodiments, each cell receptacle may also be operably coupled to an auxiliary vent channel. An opening between the auxiliary vent channel and the cell receptacle may be positioned such that the opening is not aligned with a vent direction of a vent cell of a cell to avoid solid or liquid vented substances from interacting with the opening to the auxiliary vent channel. As such, gases that vent from a failing cell may escape the battery housing via the auxiliary vent channel. Accordingly, in the event that the shared, primary vent channel is, for example, clogged due to the release of solids and liquids from a failed cell into the primary vent channel, gases from the failed cell may still escape the battery housing via the auxiliary vent channel, since the misalignment of the auxiliary vent channel opening with the vent direction of the cell inhibits or prevents clogging of the opening to the auxiliary vent channel. Some example embodiments of the vent systems described herein were developed using computational fluid dynamics (CFD) simulation, and advanced thermal simulation, and then constructed using the simulations and validating the operation using fully charged batteries, each with multiple cells.

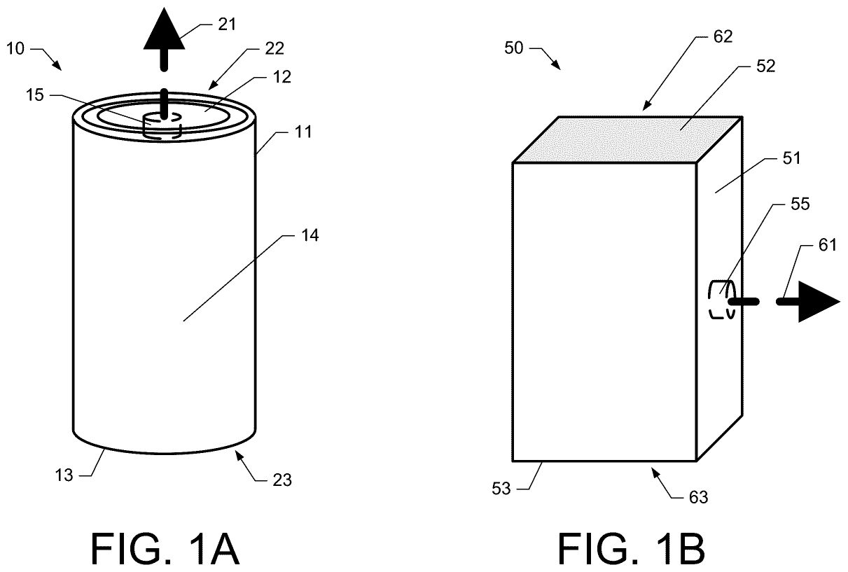

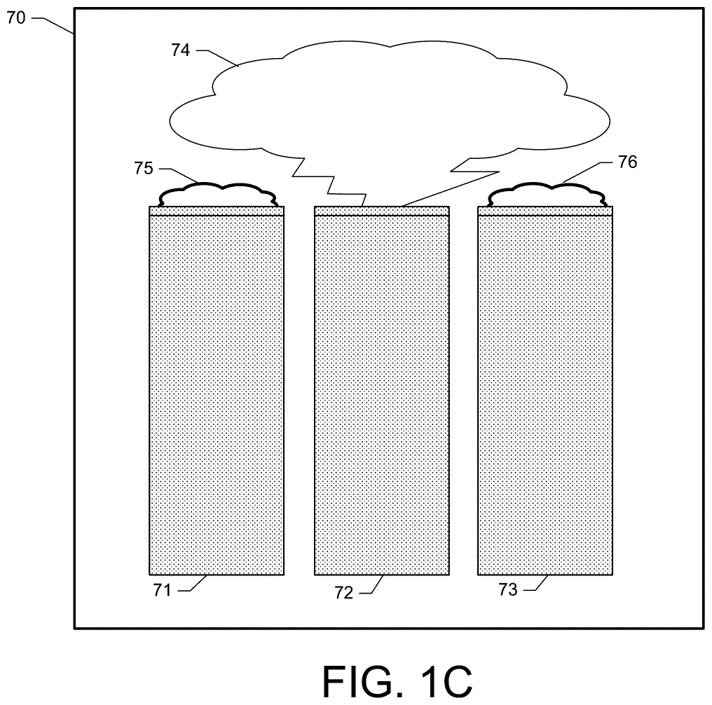

With reference to FIG. 1A, an example cell 10 for use in a battery is shown. According to some example embodiments, the cell 10 may have a cell chemistry such as, for example, a lithium-ion cell chemistry. According to some example embodiments, the cell 10 may a rechargeable cell that is configured to the charged by an external power source and discharge to provide electrical power to a load (e.g., an electric motor of a vehicle). In some implementations, the cell 10 may be connected to a plurality of other cells to form a battery capable of high-power output.

The cell 10 may include a canister 11 that, according to some example embodiments, may be cylindrical in shape. The canister 11 may define a cell sidewall 14 that extends from a top of the canister 11, i.e., a first end 22, to a bottom of the canister 11, i.e., a second end 23. The shape of the cell 10 may be elongated to define an axis that may be aligned with the elongated dimension. According to some example embodiments, the cell 10 may have electrical terminals (e.g., a positive terminal and a negative terminal). In this regard, a first terminal 12 may be disposed on a first end 22 of the cell 10 and a second terminal 13 may be disposed on a second end 23 of the cell 10. According to some example embodiments, the canister 11 may be formed of a metal, such as, for example aluminum.

According to some example embodiments, the canister 11 may be formed of a metal, such as, for example aluminum. The canister 11 may be formed such that the second end 23 with a vent valve 15 may be structurally stronger relative to the first end 22. For example, prior to assembly, the first end 22 of the canister 11 may be open and the second end 23 of the canister 11 may be closed or sealed either via crimping, welding, or molding. With the second end 23 being structurally stronger, in the event that the cell 10 should fail involving the creation of high pressures, any internal cell substances that may be forced out of the canister 11 would escape out the first end 22 of the canister 11 in the vent direction 21. As such, the first end 22 may be referred to as the vent end of the cell 10 and the second end may be referred to as the non-vent end of the cell 10.

As indicated above, and as further described herein, a cell of a battery (e.g., a lithium-ion (Li-ion) cell of a battery) may, for example, may fail in a variety of manners. In some instances, pressure internal to the cell begins to rise until a vent valve of the cell opens to alleviate the pressure by expelling gases within the cell. In some instances, the cell may continue to operate after such a venting event for a long duration of time. However, in some instances, the cell may continue to fail, despite the operation of the vent valve, and the cell may have a thermal runaway failure event where thermal conditions within the cell reach a point that the cell chemistry can ignite causing, for example, damage to the cell and surrounding cells of the battery.

Thermal runaway of a cell can occur in scenarios which can be classified into two broad classes, namely externally-caused or internally-caused. Externally-caused thermal runaway and associated fires can be the result of electrical “abuse” (e.g., over-charging, fast charging, over-discharging, external short-circuit, etc.), mechanical abuse (e.g., container rupturing due to, for example, compression), or thermal abuse (e.g., exposure to external heat, or charging while the cell is thermally cold). Internally-caused thermal runaway and associated combustion can be a result of, for example, internal short-circuit and degradation of, or rupture in, the separator (that separates the cell anode from the cell cathode), degradation of the chemicals in the cell anode, cathode, anode current-collector, or cathode-current collector. Further, external abuse conditions can lead to similar effects, such as an internal short circuit within the cell.

Internal shorts or chemical degradation can occur at different times. In some instances, both can occur gradually due to calendar and cycle-life aging, or due to impurities in materials and manufacturing defects. Thermal runaway and associated heating and pressures in a single cell may be initiated by a set of cascading chemical reactions between the reactive materials in the electrodes and the solvents in the electrolyte of the cell. The liquid solvents and solid structural materials, such as separators, may contain hydrocarbons that can be combustible. Further, external oxygen may not be needed to support combustion within the cell, because it is often the case that the cathode of the cell contains oxidizing chemicals that can facilitate combustion.

Internal shorts within a cell can occur for a variety of reasons, including foreign-object-debris (FOD) inside the cell, excessive current flow through the cell, and cell heating by external sources. FOD can cause thermal runaway and associated fire when a low resistance electron-conducting path is created inside the cell between the anode and the cathode. Initially, FOD may be micron or sub-micron-size particles within the cell that grow with the charge-discharge cycles. In the initial stages of growth, FOD may not even be in contact with the anode or the cathode. FOD are, however, difficult to detect, especially if present only in the electrolyte. As such, associated failures are difficult to predict in advance.

As mentioned above, since individual cell failures occur with some frequency, many cells, including cell 10, may be equipped with a pressure-sensitive vent feature, in the form of a vent valve 15. According to some example embodiments, the vent valve 15 may be, for example, a single-use relief valve that opens when an internal pressure of the cell 10 reaches a threshold value. The vent valve 15 may be a tab, film, or other structurally weakened location of the cell 10, from which venting may occur. According to some example embodiments, the vent valve 15 may be structured to fail open when the internal pressure of the cell 10 reaches levels that would only occur in a failing cell. For example, the threshold pressure for triggering the vent valve 15 may be 175 to 180 PSI (pounds per square inch). Such pressures are typically only reached when the cell 10 is experiencing thermal abuse prior to or during a thermal runaway event.

The vent valve 15 may be configured to relieve the pressure within the canister 11 to avoid pressure build-up and a high-pressure failure. In some instances, gases from within the canister 11 may be released by the vent valve 15 to reduce the internal cell pressure. However, in some instances, rapid heating and increasing pressures may occur that cannot be alleviated by mere opening of the vent valve 15 alone. In such, instances, the vent valve 15, as a weakened location of the cell 10, may be a failure site where the canister 11 ruptures and the internal substances (e.g., solids, fluids, and gases) may expel from the rupture in a vent direction 21 that originates from the vent valve 15. As such, the location of the vent valve 15, as a likely failure site from which the internal substances may be vented or expelled, the direction that the internal substances may travel when expelled may be predictable and may be referred to as the vent direction 21 for the cell 10. According to some example embodiments, the vent direction 21 may, in some example embodiments, be orthogonal from the surface from which the vent direction 21 extends. In example embodiments where the vent valve 15 is disposed on a curved surface or otherwise non-planar surface, the vent direction 21 may be a direction that is orthogonal to the a tangent plane that passes through the vent valve 15 and extends from the vent valve 15.

In this regard, FIG. 1B illustrates another example cell 50 that is not cylindrically shaped, but is otherwise similar to the cell 10 in many ways. Like the cell 10, the cell 50 may have a cell chemistry such as, for example, a lithium-ion cell chemistry. However, the cell 50 may have a canister 51 with a rectangular prism shape. The vent valve 55 may be disposed on a sidewall (e.g., an elongated external wall) of the canister 51. As such, the vent direction 61 may be orthogonal to the sidewall and extend from the vent valve 55. The cell 50 may have a first end 62, for example, with a terminal 52, and a second end 63 with a terminal 53. Cell 50 is another example of a cell structure and configuration that may be utilized in accordance with various example embodiments described herein. As further described below, regardless of the structure or configuration of the cell, according to some example embodiments, the cells may be positioned such that the vent direction is towards an opening into a primary vent channel.

With reference to FIG. 1C, a battery housing 70 is shown with three cells 71, 72, and 73 disposed therein. The cell 72 is currently failing and the pressure within the canister of cell 72 has reached a threshold level to cause the vent valve of cell 72 to open. Cells 71 and 73 are operating normally. Due to the internal temperature and pressure within the cell 72, substances that are typically liquids at room temperature may vaporize and be expelled as gases 74. Such liquid, e.g., electrolytes and other liquids, may be combustible. As such, when these combustible substances escape as gases 74, the substances can readily spread throughout the interior of the battery housing 70. Further, because the interior temperature and pressure of the cell 72 is high, when the gases 74 are exposed to the lower temperatures and pressures external to the cell 72, the gases 74 may condense and be disposed, for example, the cells 71 and 72. As such, combustible substances 75 and 76 may be deposited on surfaces of the cells 71 and 72.

If, for example, the cell 72 continues to fail and ultimately ignites due to a thermal runaway event, the combustion of the cell 72 may readily spread to combustible substances 75 and 76 and cause heating of the otherwise normally operating cells 71 and 73. As a result of the heating of cells 71 and 73, cells 71 and 73 being to fail leading to the propagation of thermal runaway within the battery housing 70. As further described below, some example embodiments described herein operate to limit or prevent this spread of combustible gases to inhibit or prevent such propagation of thermal runaway events.

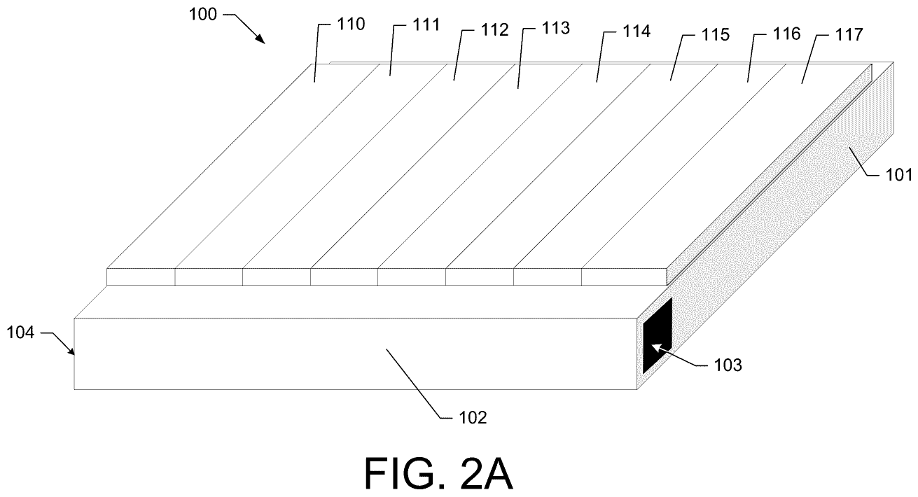

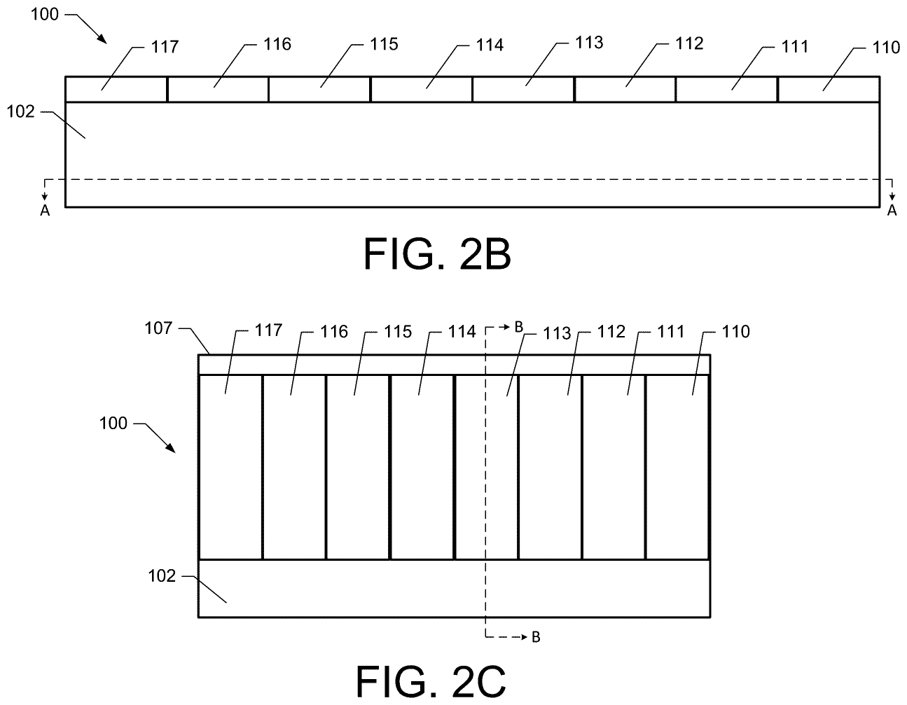

According to some example embodiments, reference is now made to FIGS. 2A, 2B, and 2C, which illustrate an example battery housing 100. While the battery housing 100 is described with respect to an implementation with cylindrical cells with a vent direction similar to cell 10, one of skill in art would appreciate that other types of cells, e.g., cell 50, may be used with some example embodiments. Accordingly, FIG. 2A is a perspective view of the battery housing 100, FIG. 2B is a front view of the battery housing 100 defining a cross-section plane at line A-A shown in FIG. 2B, and FIG. 2C is a top view of the battery housing 100 defining a cross-section plane at line B-B shown in FIG. 2C. The battery housing 100 may be an apparatus that houses a plurality of cells. The battery housing 100 is configured to house eight cells, but, according to some example embodiments, the battery housing 100 may be configured to house any number of cells. The cells that are received and held by the battery housing 100 may be, for example, cells that are the same or similar to the cell 10. The battery housing 100 may be configured to receive and hold cells in an interior space of the battery housing 100. The configuration of the interior space may have a number of functions. According to some example embodiments, the interior space configuration may position the cells for ease of electrical connection between the cells and to components external to the battery housing 100. Such electrical connections are not shown here, but one of skill in the art would appreciate that the cells can be connected in, for example, series or parallel to support desired voltages and currents. The interior space may also be configured for individual cell containment via the use of cell receptacle sidewalls. In this regard, the internal space may include individual cell compartments or cell receptacles that hold a cell in position and also substantially isolate each cell from other cells in the battery housing 100 via the use of sidewalls. These sidewalls of the cell receptacles may operate to, for example, inhibit the spread of combustible gases and condensation to other cells to avoid the scenario described with respect to FIG. 1C. Further, the sidewall may also be formed of materials that limit or inhibit heat conduction between cell receptacles. For example, according to some example embodiments, the walls of the cell receptacles and other walls of the battery housing 100 may be formed of a metal, a plastic, or other materials that support the mechanical and thermal requirements of the battery housing 100. In this regard, according to some example embodiments, the sidewalls may be formed of materials that include metals, metallic alloys, ceramics, metal-ceramic composites, polymers, polymer composites, or the like. In some example embodiments, the walls of the cell receptacle may be formed of a resin-infused molded plastic. In some example embodiments, the resin-infused molded plastic walls may be subjected to a metallization process to, for example, mechanically strengthen the molded plastic walls. In this regard, the metallization may involve applying a layer of, for example, nickel on the sidewall surfaces of the cell receptacles and the battery housing 100. The sidewalls of the cell receptacles may also be structured and aligned to direct the venting of substances from a failing cell into a desired direction to permit such substances readily escape the battery housing 100 as exhaust via a vent channel.

According to some example embodiments, the battery housing 100 may be included of a cell compartment 101, a primary vent channel portion 102, and a plurality of auxiliary vent channel compartments, in this case eight auxiliary vent channel compartments 110-117. The cell receptacles described above may be disposed in the cell compartment 101. A primary vent channel may be located in the primary vent channel portion 102 that is positioned adjacent to openings in the cell receptacles to receive vented substances and directionally expel the vented substances from the battery housing 100 via external openings 103 and 104 at the ends of the primary vent channel portion 102 and into an external space. Additionally, according to some example embodiments, each cell receptacle may have a dedicated auxiliary vent channel that is disposed within a respective auxiliary vent channel compartment (e.g., auxiliary vent channel compartments 110-117). As such, according to some example embodiments, the battery housing 100 may include a plurality of vent channels that may be configured into a network of vent channels. According to some example embodiments, the auxiliary vent channels may be secondary channels that also permit venting of cell substances. According to some example embodiments, an auxiliary vent channel may be configured to permit the continued escape of, for example, gases, when the primary vent channel is blocked or clogged, as described below. As such, while the auxiliary vent channel may operate to support venting even when the primary vent channel is clear, the auxiliary vent channel may also operate as a contingency vent channel that provides an alternative pathway for cell substances when, for example, the primary vent channel cannot support the escape of vented substances. In this regard, according to some example embodiments, each auxiliary vent channel may be isolated from the primary vent channel 110 and the other auxiliary vent channels. Although not shown in FIGS. 2A and 2B, each auxiliary vent channel compartment 110-117 may include an external opening, for example, at the back of the battery housing 100, to expel vented substances from the battery housing 100 and into an external space.

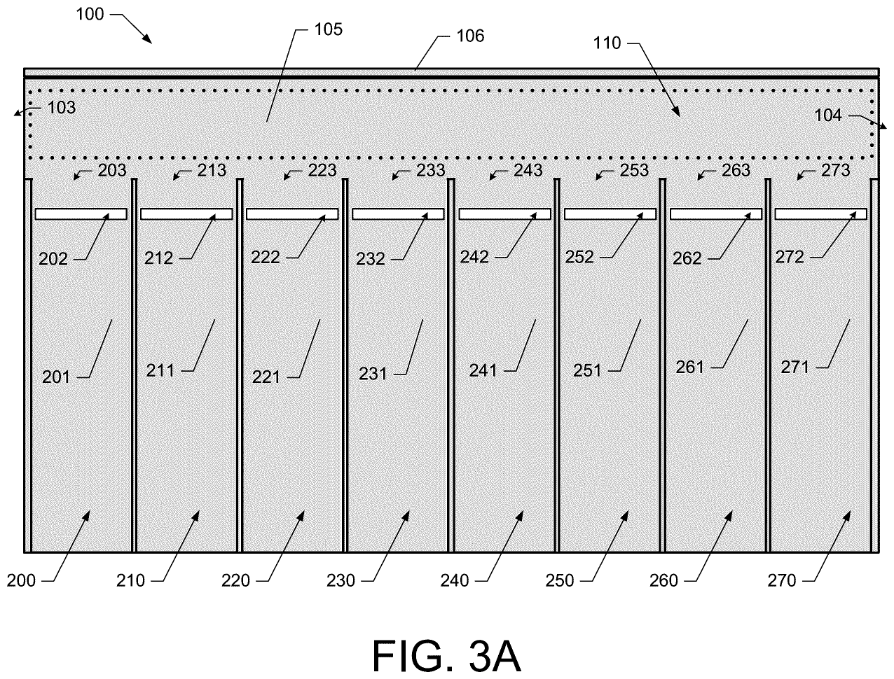

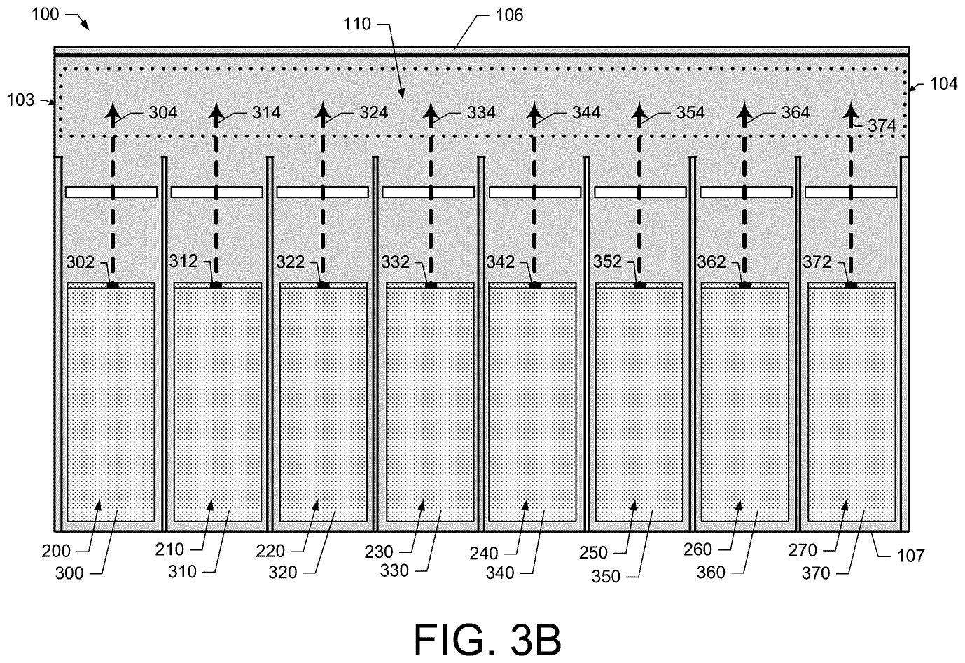

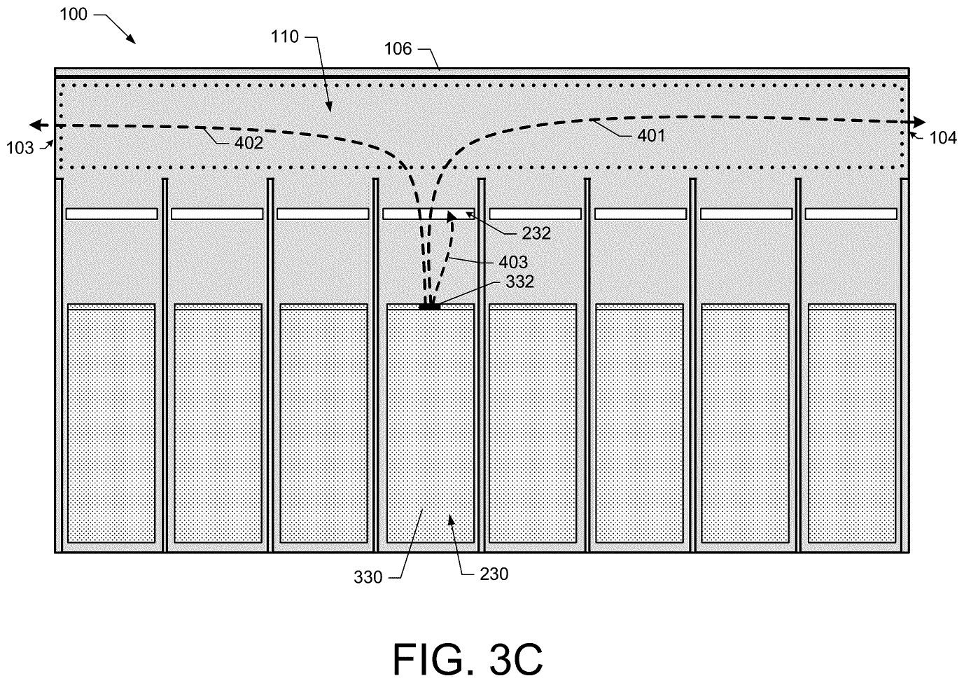

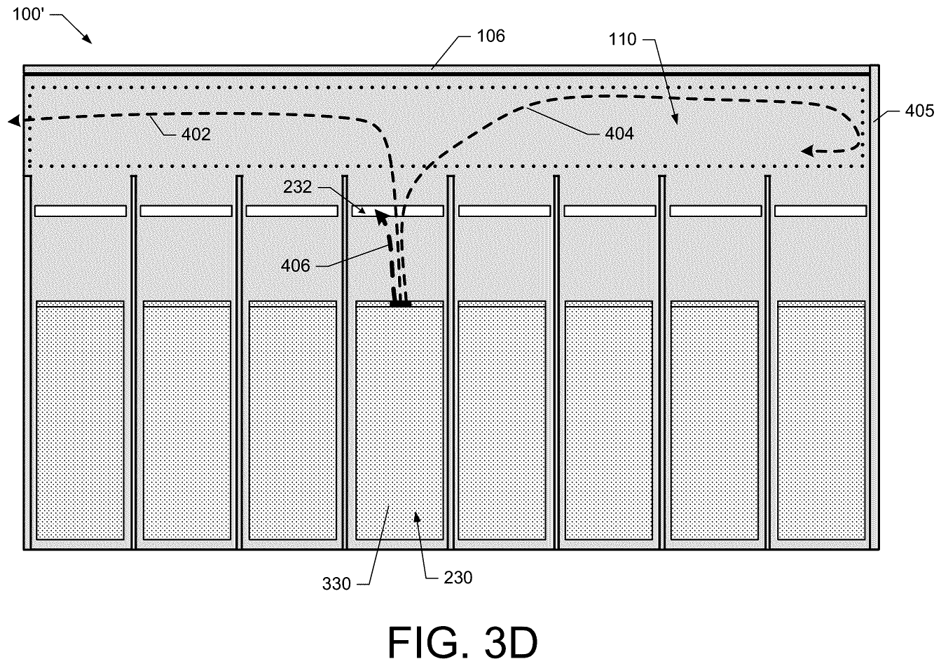

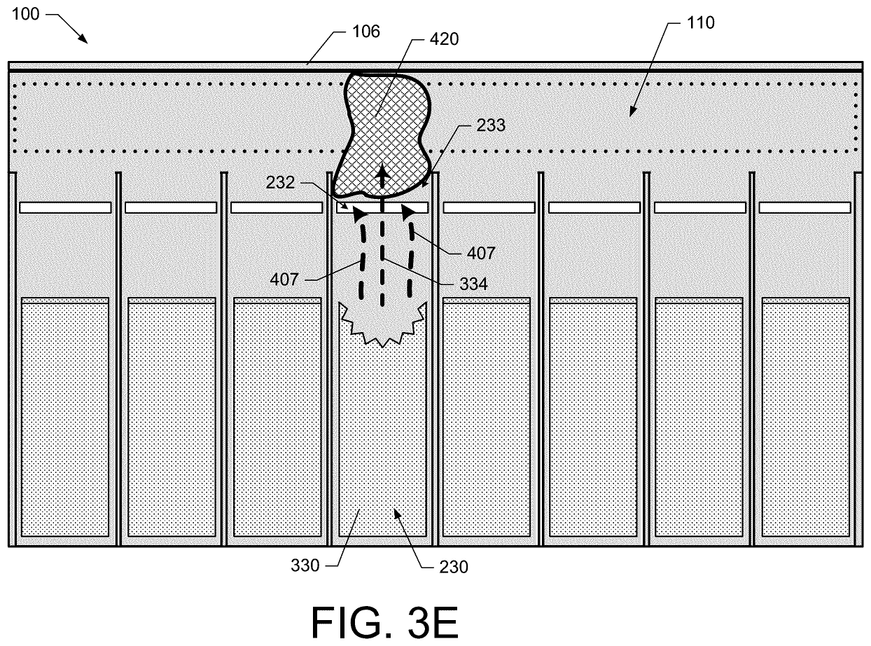

Referring now to FIG. 3A, the battery housing 100 is shown in cross-section taken at line A-A in FIG. 2B. FIG. 3A reveals the internal construction of the battery housing 100 without having cells installed therein. As such, the view provided in FIG. 3A shows the interior of the battery housing 100 with the base removed to view the structure the interior surfaces in relation to the top 105 of the cell compartment 101 and the primary vent channel portion 102. The battery housing 100 may include eight cell receptacles 200, 210, 220, 230, 240, 250, 260, and 270. Each cell receptacle 200, 210, 220, 230, 240, 250, 260, and 270 includes sidewalls including a sidewall 201, 211, 221, 231, 241, 251, 261, and 271, respectively; an auxiliary vent channel opening 202, 212, 222, 232, 242, 252, 262, and 272, respectively; and a primary vent channel opening 203, 213, 223, 233, 243, 253, 263, and 273. The auxiliary vent channel openings 202, 212, 222, 232, 242, 252, 262, and 272 may be disposed on the sidewalls 201, 211, 221, 231, 241, 251, 261, and 271, respectively. The cell receptacles 200, 210, 220, 230, 240, 250, 260, and 270 may be structured and configured in the same or similar manner. According to some example embodiments, the cell receptacles 200, 210, 220, 230, 240, 250, 260, and 270 may share a sidewall with an adjacent cell receptacle. The cell receptacles 200 and 270 on the ends of the battery housing 100 include sidewalls that are adjacent to the exterior of the battery housing 100.

Since the cell receptacles are generally similar in construction, a detailed description of cell receptacle 210 will now be provided with the understanding that the description may be applicable to each of the cell receptacles of the battery housing 100. In this regard, cell receptacle 210 may be enclosed on its sides by sidewall with one end of the cell receptacle 210 being open to the primary vent channel 110 via the primary vent channel opening 213. Although the primary vent channel opening 213 may be a true open passage in some example embodiments, the primary vent channel opening 213 may include a seal or other pressure-sensitive barrier that may prevent dust and debris from entering cell receptacle 210 during normal operation, but would readily open when, for example, the pressure in the cell receptacle 210 rises to a certain threshold to permit venting of a cell in the cell receptacle 210 via the primary vent channel opening 213 into the primary vent channel 110.

As mentioned above, the sidewalls of the cell receptacle 210 may operate as physical and thermal barriers between the cell receptacle 210 and its adjacent cell receptacles. In this regard, according to some example embodiments, the sidewalls may also be configured to operate as barriers to cell venting event occurring in other cell receptacles. Further, according to some example embodiments, the sidewalls may extend toward the primary vent channel beyond a position (e.g., an installed position) configured to receive a cell in the receptacle to inhibit the spreading of ejected gases from the cell into adjacent receptacles. The sidewalls may operate not only to inhibit the conduction of thermal energy, but also mechanical energy that may be the result of a rapid pressure change in the cell receptacle 210 due to a cell within the cell receptacle 210 experiencing a thermal runaway event. Additionally, as mentioned above the structure of the sidewalls may inhibit or prevent the spread of combustible gases within the battery housing 100. The sidewalls, according to some example embodiments, may be constructed to have specific mechanical and thermal properties. According to some example embodiments, the material used to form the sidewalls may be formed using materials that include gas pockets or bubbles that limit thermal conduction relative to a comparable solid material that does not include such pockets or bubbles. According to some example embodiments, such a material may be a plastic or a hydrocarbon material. In some example embodiments, such pockets or bubbles may be filled with air or another gas that inhibits thermal conduction or combustion, such as, for example an inert gas. Such pockets or bubbles may also reduce the weight of the material, thereby reducing the weight of the battery housing 100. In some example embodiments, the material may additionally or alternatively be infused with a resin that strengthens the material. For example, a resin may be combined with a plastic in a vacuum chamber to disperse and infuse the resin into the plastic. The sidewalls of the cell receptacle 210 may be formed with such a substance via printing process (e.g., an additive or other three-dimensional printing process). According to some example embodiments, the sidewalls may be printed using a printable metal, such as stainless steel. Additionally or alternatively, the material used to initially form the sidewalls may be metallized, for example, in instances where the material does not include a metal, to further increase the mechanical strength of the material. In this regard, according to some example embodiments the outer surfaces of the sidewalls may be metallized with a layer (e.g., about 135 microns thick) of metal, such as nickel, which may be applied to, for example, a resin-infused plastic material. While the sidewalls of the cell receptacle 210 are described as being formed in these ways, it is understood that any of the walls or structures of the battery housing 100 may be formed in these same ways.

As mentioned above, the primary vent channel 110 may be disposed on one end of the cell receptacle 210 (and similarly the other cell receptacles). According to some example embodiments, the primary vent channel 110 may be shared with other cell receptacles such that a plurality of cell receptacles may each vent into the primary vent channel 110 via respective openings in the primary vent channel 110. The primary vent channel 110 may also have one or more external openings (e.g., external openings 103 and 104) to an external space. According to some example embodiments, the primary vent channel 110 may be a linear channel that, for example, intersects with each of the cell receptacles (e.g., at a ninety-degree angle) at a primary vent channel opening for each cell receptacle. While the primary vent channel 110 of battery housing 100 may extend linearly, according to some example embodiments, the primary vent channel 110 may alternatively be nonlinear such as, for example, piecewise linear, curved, or the like.

Returning to the description of the cell receptacle 210, according to some example embodiments, the cell receptacle 210 may also include an auxiliary vent channel opening 212. Again, while the auxiliary vent channel opening 212 may be a true open passage in some example embodiments, the auxiliary vent channel opening 212 may include a seal or other pressure-sensitive barrier that may prevent dust and debris from entering cell receptacle 210 during normal operation, but would readily open when, for example, the pressure in the cell receptacle 210 rises to a certain threshold to permit venting of a cell in the cell receptacle 210 via the auxiliary vent channel opening 212 and an associated auxiliary vent channel. The auxiliary vent channel opening 212 may be disposed on one of the sidewalls (as shown in FIG. 3A sidewall 211) of the cell receptacle 210. As such, based on the structure of cell receptacle 210, the auxiliary vent channel opening 212 may be disposed on, for example, a top sidewall. Alternatively, according to some example embodiments, the auxiliary vent channel opening 212 may be disposed on, for example, a bottom sidewall (not shown). Further, according to some example embodiments, the cell receptacle 210 may have more than one auxiliary vent channel opening and associated auxiliary vent channels, for example, with an auxiliary vent channel opening on a top sidewall and an auxiliary vent channel opening on a bottom sidewall. As further described below, because the auxiliary vent channels may be primarily beneficial for permitting gases to escape when the primary vent channel 110 is unavailable or insufficient, having the auxiliary vent channel opening 212 in a position that is opposite the direction of gravity can operate to inhibit or prevent non-gas substances from interacting with the auxiliary vent channel opening 212, as further described below. Unlike the primary vent channel 110, which may be a shared vent channel, each cell receptacle may include a respective auxiliary vent channel opening and associated auxiliary vent channel as an additional vent pathway that is, in some example embodiments, isolated and therefore unaffected by events occurring in other cell receptacles.

Now referring to FIG. 3B, the battery housing 100, as shown in cross-section as provided in FIG. 3A, is now shown with cells installed in the cell receptacles. In this regard, cells 300, 310, 320, 330, 340, 350, 360, and 370 are installed in cell receptacles 200, 210, 220, 230, 240, 250, 260, respectively. The cells 300, 310, 320, 330, 340, 350, 360, and 370 may be the same or similar to the cell 10. As such, each of the cells 300, 310, 320, 330, 340, 350, 360, and 370 may define a vent direction 304, 314, 324, 334, 344, 354, 364, and 374 as described above for cells 10 or 50. As such, the cells 300, 310, 320, 330, 340, 350, 360, and 370 may be installed to position vent directions 304, 314, 324, 334, 344, 354, 364, and 374 towards the primary vent channel 110. According to some example embodiments, to ensure alignment of the vent directions 304, 314, 324, 334, 344, 354, 364, and 374, the cell receptacles 200, 210, 220, 230, 240, 250, 260, respectively, may be sized to maintain the cells 300, 310, 320, 330, 340, 350, 360, and 370 in respective installed positions such that their vent valves 302, 312, 322, 332, 342, 352, 362, and 372 are proximate the primary vent channel 110.

Referring to cell 310 as an example for the cells, cell 310 may be installed such that the vent valve 312 is positioned proximate to the primary vent channel 110 and oriented such that the vent direction 314 extending from the vent valve 312 is towards and into the primary vent channel 110. Further, the vent direction 314 may be towards a primary vent channel wall 106 that is positioned opposite the vent valve 312 of the cell 310. In this installed orientation, if the cell 310 has a thermal runaway event that causes the cell 310 to rupture at the vent valve 312 and expel internal substances, the internal substances would be forced in the vent direction 314 into the primary vent channel 110 and towards the primary vent channel wall 106. Upon entering the primary vent channel 110, the expelled internal substances (e.g., solids, liquids, and gases) may be forced through the primary vent channel 110 to the external openings 103 and 104 of the primary vent channel 110. According to some example embodiments, due to the potential high forces that may be applied to the primary vent channel wall 106, the primary vent channel wall 106 may be constructed to have a stronger mechanical strength than other walls (e.g., cell receptacle sidewalls) of the battery housing 100. For example, the primary vent channel wall 106 may be formed to be thicker than other walls or the primary vent channel wall 106 may be formed with stronger materials than the other walls of the battery housing 100.

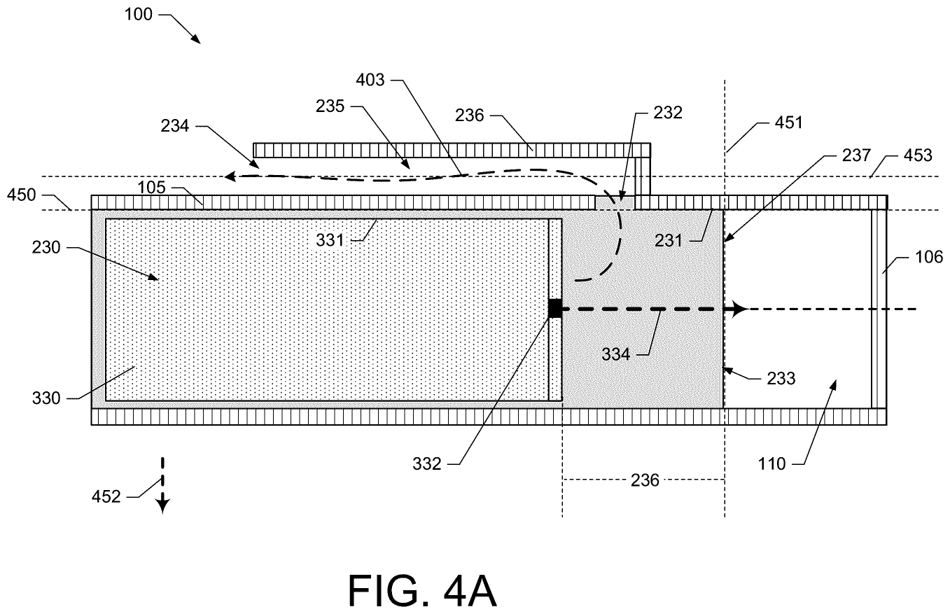

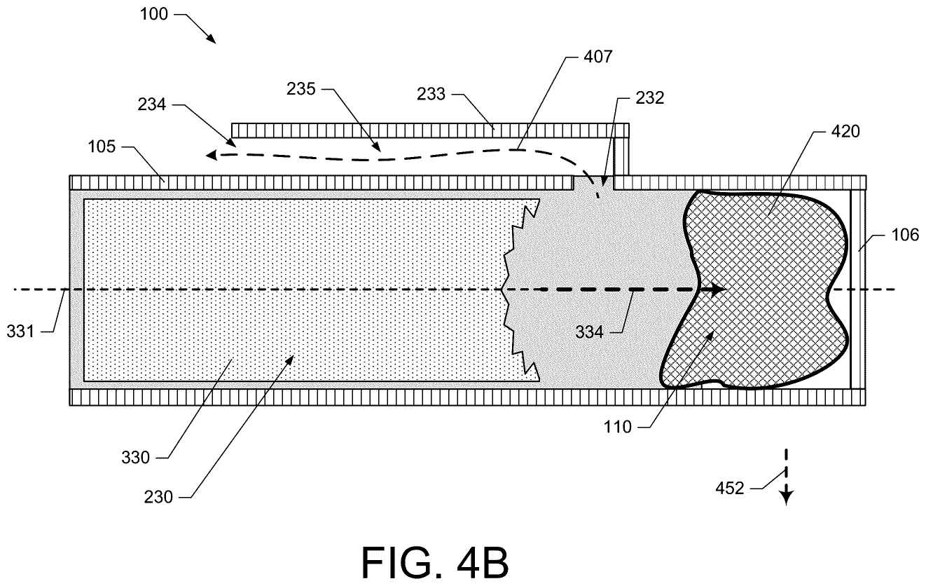

Additionally, the cell receptacle 230 may include sidewalls, as described above that provide isolation for the cell 330 from the other cells installed in the battery housing 100. In this regard, the sidewalls of the cell receptacle 230 may extend from a back end 107 of the battery housing 100 towards the primary vent channel 110. However, a length of the sidewalls of the cell receptacle 230 may longer than a length of the cell 330, and therefore the sidewalls of the cell receptacle 230 may extend towards the primary vent channel 110 beyond an end of the installed cell 330 closest to the primary vent channel 110. According to some example embodiments, the sidewalls of the cell receptacle 230 may extend beyond the end of the installed cell 330 by a distance (e.g., distance 236 in FIG. 4A) that reduces the movement energy of a gas expelled from the vent valve 332 to limit or eliminate any backflow of such gas into another cell receptacle. According to some example embodiments, the sidewalls of the cell receptacle 230 may extend beyond the end of the installed cell 330 by a distance (e.g., distance 236 of FIG. 4A) that is, for example, one-third a length of the cell 330 or another ratio to the length of the cell 310.

Now referring to FIGS. 3C and 4A, the battery housing 100 is shown with installed cells, where cell 330, received and disposed within cell receptacle 230 in an installed position is experiencing a venting event. In FIG. 3C, the battery housing 100 is shown in cross-section as provided in FIG. 3A, and in FIG. 4A, the battery housing 100 is shown in cross-section taken at line B-B shown in FIG. 2C. Regardless of the cause of the venting event, the pressure in the cell 330 may have reached a level to open the vent valve 332 of the cell 330 such that gases may be expelled from the vent valve 332. Due to the positioning and orientation of the vent valve 332, the internal substances may be expelled in the vent direction 334 towards an end 237 of the cell receptacle 230, through the primary vent channel opening 233, and into the primary vent channel 110. As indicated by arrows 401 and 402 in FIG. 3C, the internal substances may travel into and along the primary vent channel 110 to the external openings 103 and 104.

In this regard, the primary vent channel 110 may be positioned adjacent to the cell 330, as described above and shown in FIG. 4A. Additionally, the primary vent channel 110 may intersect with the vent direction 334. As such, internal substances (e.g., solid and liquid substances) of the cell 330 may travel along the vent direction 334 and expel into the primary vent channel 110. Some amount of the internal substances may pass into the auxiliary vent channel opening 232, as indicated by arrow 403, and be expelled via the associated auxiliary vent channel 235 and into an external space via external opening 234 in the auxiliary vent channel 235. However, the auxiliary vent channel opening 232, according to some example embodiments, is not aligned with the primary vent channel opening and a position of a vent valve 332 when the cell 330 is in an installed position within the cell receptacle 230.

As shown in FIG. 4A, the auxiliary vent channel 235 may be disposed, for example, above the cell receptacle 230 (although other configurations are contemplated), with arrow 452 indicating the direction of the gravitational force when the battery housing 100 is installed in a device to be powered. In this regard, the cell 330 may be installed, according to some example embodiments, such that the cell sidewall 331 is positioned adjacent or proximate to the sidewall 231 of the cell receptacle 230. Therefore, the vent direction 334 may be perpendicular to the direction of the gravitation force (arrow 452). As such, due to gravity, expulsion of at least the solid and liquid internal substances of the cell 330 may be pulled by gravity away from the top sidewall 231 and, thus the auxiliary vent channel opening 232, in some example embodiments.

In the example embodiment of FIG. 4A, the auxiliary vent channel 235 opens to the external space at a back end. The auxiliary vent channel 235 may be defined by at least an upper sidewall 231 that extends from the auxiliary vent channel opening 232 to the external opening 234. According to some example embodiments, to inhibit interaction of, for example, the solid and liquid internal substances with the auxiliary vent channel opening 232, the auxiliary vent channel opening 212 may be positioned to not intersect with the vent direction 334. Accordingly, by positioning the auxiliary vent channel opening 232 out of alignment with the vent direction 334, blockage of the auxiliary vent channel opening 232 is inhibited or avoided when a venting event in the cell 330 occurs.

From a structural perspective, according to some example embodiments, the auxiliary vent channel opening 232 may be disposed in the cell receptacle sidewall 231, such that the auxiliary vent channel opening 232 is between the cell receptacle 230 and the auxiliary vent channel 235. Further, the vent valve 332 of the cell 330 may be proximate the end 237 of the cell receptacle 230 and the primary vent channel opening 213 may be disposed between the cell receptacle 230 and the primary vent channel 110. Additionally, according to some example embodiments, the auxiliary vent channel opening 232 may be disposed in a plane 450 that is parallel with the longitudinal axis and orthogonal to a plane 451. The primary vent channel opening 233 may be disposed in the plane 451. Additionally, according to some example embodiments, a plane 453 that passes through the auxiliary vent channel 235 may be defined that does not intersect with the primary vent channel 110 and is parallel to the longitudinal axis of the cell 330.

FIG. 3D is similar to FIG. 3C with the exception of the battery housing 100 being modified to be battery housing 100′, which has a wall extension at 405 (rather than the external opening 104 of battery housing 100) that seals the primary vent channel 110 at one end. The battery housing 100′ may be implemented in an application where, for example, the primary vent channel 110 can only exhaust in a certain direction due to constraints of the device that is being powered (e.g., positioning of the battery within a vehicle chassis). Although not shown, the auxiliary vent channels may have a similar constraint and may only be able to exhaust in a particular direction.

In such situations where the pathway to an external opening from the primary vent channel 110 is more limited, higher pressures can occur within the primary vent channel 110. Arrow 404 indicates that some internal substances of the cell 330 may travel in the “dead end” direction within the primary vent channel 110, thereby resulting in increased pressures relative to the pressures present in the scenario of FIG. 3C. In example embodiments where the primary vent channel 110 may be limited in this way, the presence and operation of the auxiliary vent channel via the auxiliary vent channel opening 232 is increasingly beneficial. Due to the higher pressures, additional internal substances, such as gases, may escape through the associated auxiliary vent channel via the auxiliary vent channel opening 232 as indicated by arrow 406.

Now referring to FIGS. 3E and 4B, the battery housing 100 is shown in a scenario where the cell 330 has undergone a thermal runaway event that resulted in a rupture of the vent end of the cell 330 and the expelling of solid and liquid internal substances in the vent direction 334 forming a blockage 420 of the primary vent channel 110. In FIG. 3E, the battery housing 100 is shown in cross-section as provided in FIG. 3A, and in FIG. 4B, the battery housing 100 is shown in cross-section taken at line B-B in FIG. 2C.

It is not uncommon for a failure of a cell to cause two-thirds of its internal substances (i.e., solids, liquids, and gases) to be expelled from the canister of the cell. As such, a scenario where such internal substances form a blockage 420 in the primary vent channel 110 is not uncommon. When such a failure occurs, a cell may transition from seemingly proper operation to expelling the solid and liquid portions of the internal substances in about 300 milliseconds. As such, the solid and liquid internal substances may be forced into the primary vent channel 110 at temperatures and velocities that are likely form a blockage 420. Immediately after the solids and liquids are expelled (and to some degree while the solids and liquids are expelled), gases are released from the failed cell 330. As a result, if the primary vent channel 110 was blocked with no path for such gases to escape, then the pressures within the, now sealed, cell 330 could increase until a more catastrophic failure occurs that likely results in the propagation of thermal runaway to other cells within the battery housing 100.

However, according to some example embodiments, the auxiliary vent channel opening 232 may be configured to provide another pathway for the escape of such gases, thereby avoiding the high pressures that would otherwise result from the primary vent channel opening 233 being blocked. As indicated by arrows 407, gases expelled from the cell 330 may escape through the auxiliary vent channel opening 232 to an external space via the associated auxiliary vent channel 235. The auxiliary vent channel opening 232, according to some example embodiments, may be positioned to avoid interaction with the solid and liquid internal substances that could block the auxiliary vent channel opening 232. Even in the event that the auxiliary vent channel opening 232 is blocked, such blockage would not affect any venting that may occur in the other cells, since the auxiliary vent channels of each cell receptacle are isolated from each other, according to some example embodiments. Accordingly, a blockage of one auxiliary vent channel, according to some example embodiments, has no impact on any other auxiliary vent channel due to their isolated configuration.

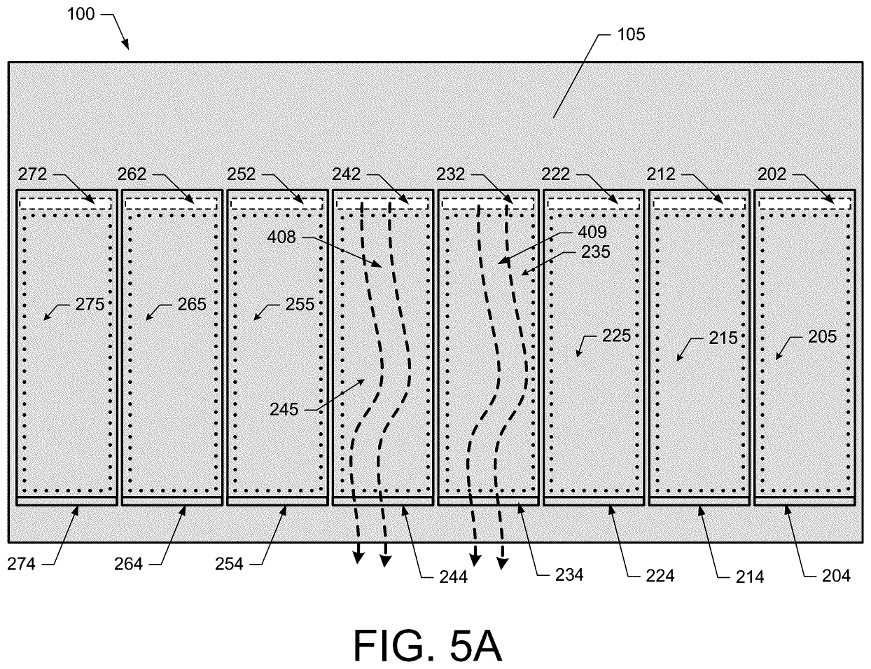

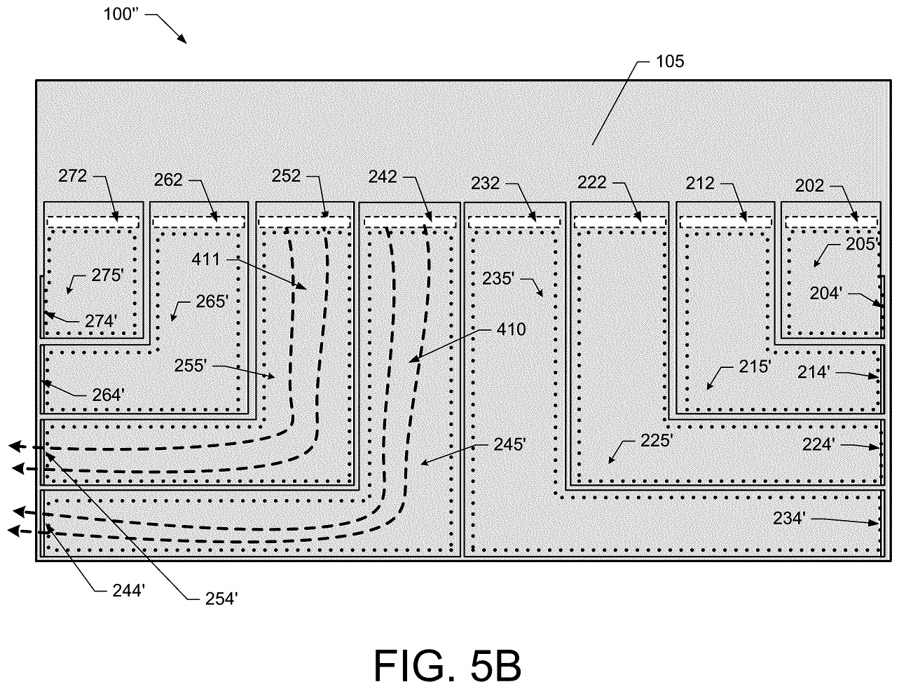

Now referring to FIGS. 5A and 5B, some example configurations of auxiliary vent channels are shown. In this regard, with respect to FIG. 5A, a top view of the battery housing 100 is shown. The battery housing 100 may include a plurality of auxiliary vent channels that have a linear configuration extending between the auxiliary vent channel openings and the respective external openings. Accordingly, the auxiliary vent channel opening 202 may be an ingress from the cell receptacle 200 into the auxiliary vent channel 205 that extends linearly rearward leading to the external opening 204. In the same manner, each of auxiliary vent channel openings 212, 222, 232, 242, 252, 262, and 272 may be an ingress from the cell receptacles 210, 220, 230, 240, 250, 260, and 270, respectively, into the auxiliary vent channels 215, 225, 235, 245, 255, 265, and 275, which each extend linearly rearward to the external openings 214, 224, 234, 244, 254, 264, and 274, respectively.

As mentioned above, each of the auxiliary vent channels 205, 215, 225, 235, 245, 255, 265, and 275 may be separated and isolated from each other to prevent any cross contamination or blockage between the channels. In this regard, as shown in FIG. 5A, a vent event within cell receptacle 240 causing venting indicated by arrows 408 traveling from the auxiliary vent channel opening 242 to the external opening 244 has no interaction with venting due to a simultaneous vent event in cell receptacle 230 as indicated arrows 407 traveling from the auxiliary vent channel opening 232 to the external opening 234.

Further, with respect to FIG. 5B, a top view of a battery housing 100″, which is the same as battery housing 100 with the exception of the routing of the auxiliary vent channels, is shown. The battery housing 100″ may include a plurality of auxiliary vent channels that have a nonlinear (e.g., a piecewise, L-shaped) configuration extending between the auxiliary vent channel openings and the respective external openings. While the nonlinear configuration of the auxiliary vent channels is piecewise linear in this example embodiment, any nonlinear configuration may be implemented, such as, for example, curved, stacked one above the other, or the like. Accordingly, the auxiliary vent channel opening 202 may be an ingress from the cell receptacle 200 into the auxiliary vent channel 205′ that extends in a nonlinear fashion to the external opening 204′. In the same manner, each of auxiliary vent channel openings 212′, 222′, 232′, 242′, 252′, 262′, and 272′ may be an ingress from the cell receptacles 210, 220, 230, 240, 250, 260, and 270, respectively, into the auxiliary vent channels 215′, 225′, 235′, 245′, 255′, 265′, and 275′, which each extend nonlinearly toward sides of the battery housing 100″ to the external openings 214′, 224′, 234′, 244′, 254′, 264′, and 274′, respectively.

As mentioned above, each of the auxiliary vent channels 205′, 215′, 225′, 235′, 245′, 255′, 265′, and 275′ may be separated and isolated from each other to prevent any cross contamination or blockage between the channels. In this regard, as shown in FIG. 5B, a vent event within cell receptacle 240 causing venting indicated by arrows 410 traveling from the auxiliary vent channel opening 242 along a nonlinear path to the external opening 244′ has no interaction with venting due to a simultaneous vent event in cell receptacle 250 as indicated arrows 411 traveling along a nonlinear path from the auxiliary vent channel opening 252 to the external opening 254′.

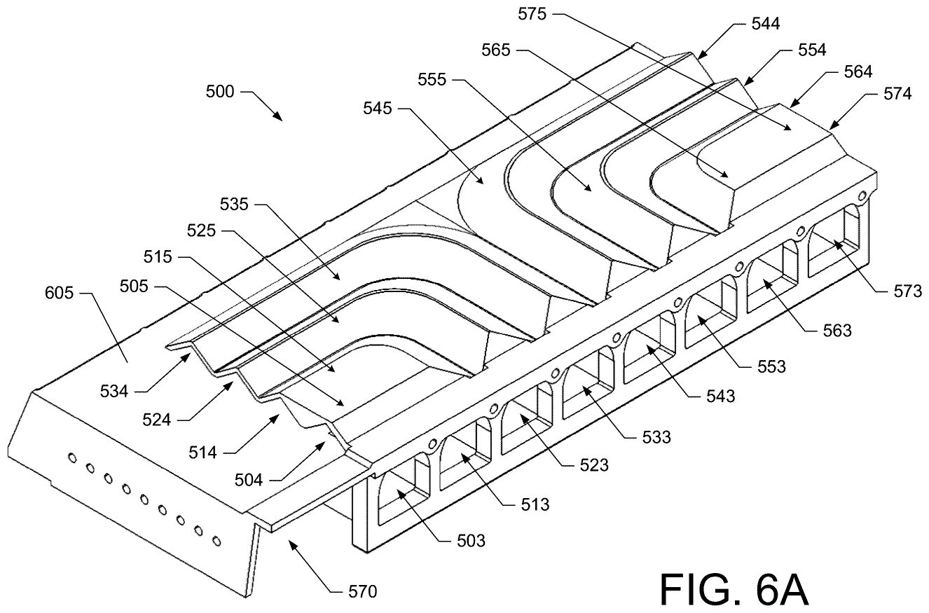

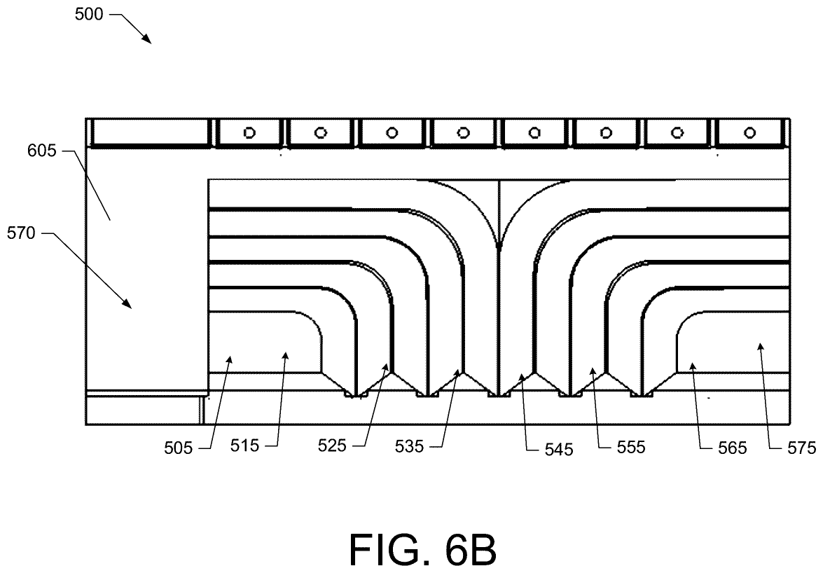

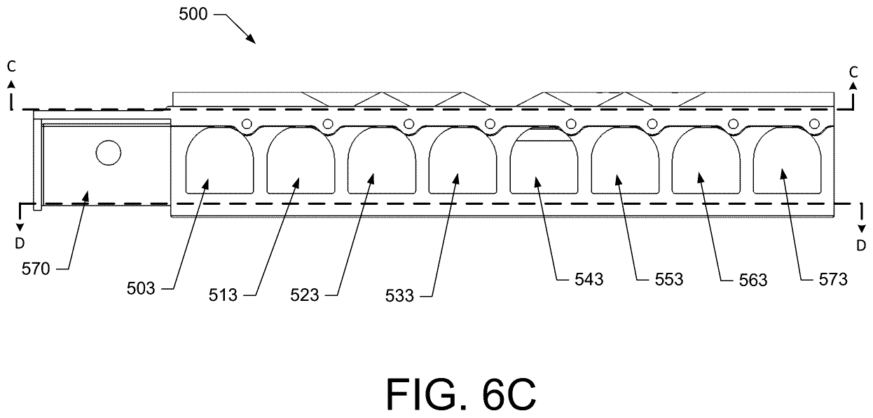

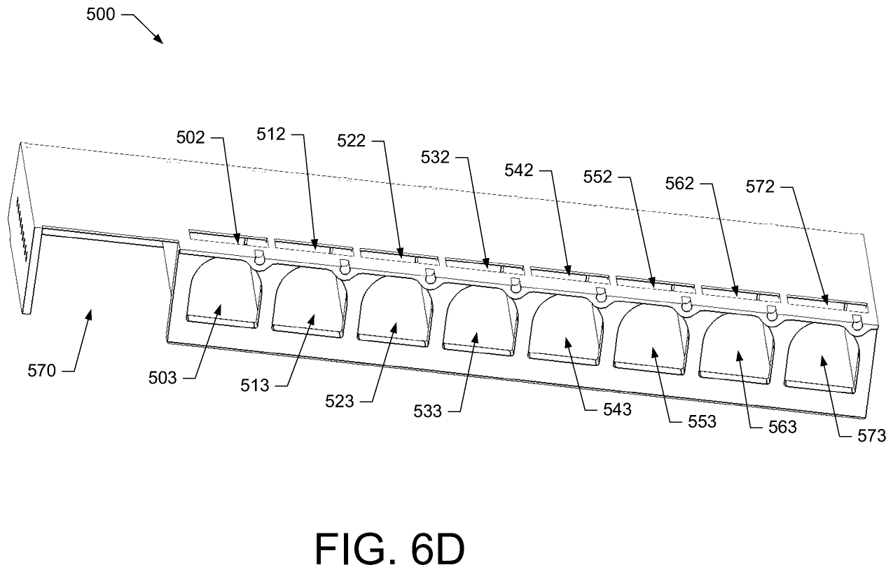

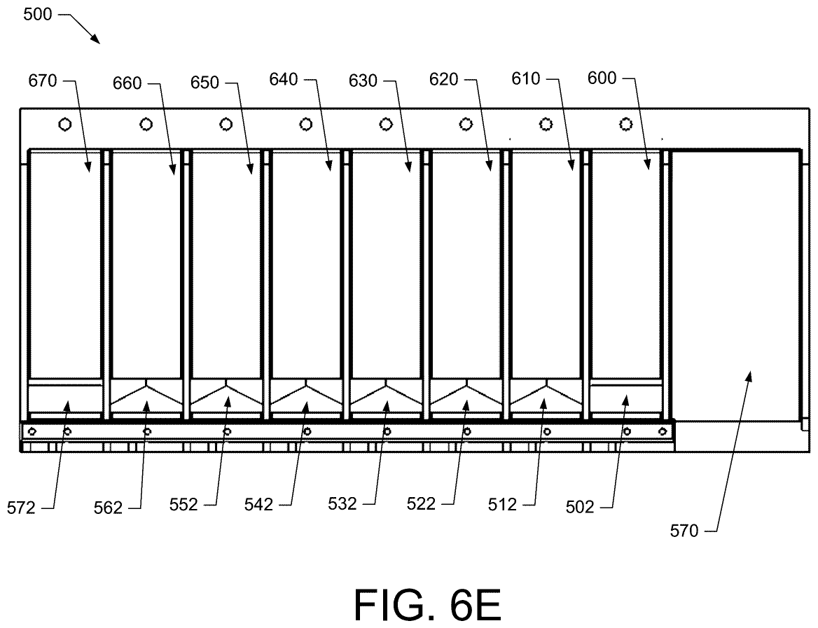

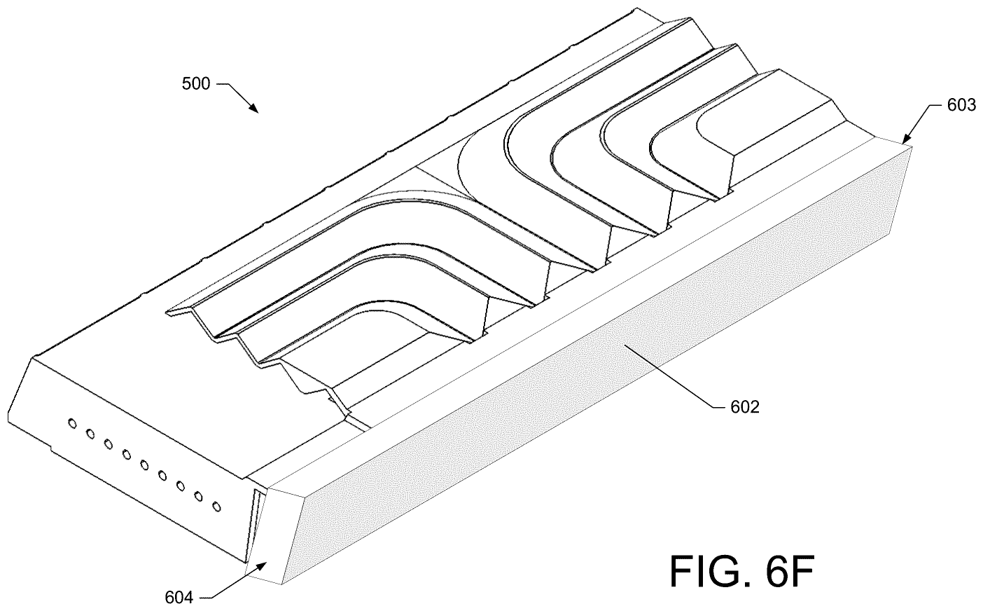

FIGS. 6A to 6F will now be described which illustrate another example embodiment of the battery housing 500 having auxiliary vent channels. FIG. 6A illustrates a perspective top view of the battery housing 500, FIG. 6B illustrates a top view of the battery housing 500, FIG. 6C illustrates a front view of the battery housing 500, FIG. 6D illustrates a perspective cross-section perspective view of the battery housing 500 taken at line C-C shown in FIG. 6C, FIG. 6E illustrates a bottom cross-section view of the battery housing 500 taken at line D-D shown in FIG. 6C, and FIG. 6F illustrates a perspective top view of the battery housing 500 including an enclosure for a primary vent channel.

In this regard, the battery housing 500 may be similar to the battery housing 100, but with a different structural design. Initially, the battery housing 500 may include a battery management system receptacle 570 configured to receive and maintain circuity for connecting to and monitoring characteristics of the cells installed within the battery housing 500. Additionally, the battery housing 500 may include cell receptacles 600, 610, 620, 630, 640, 650, 660, and 670. Each cell receptacle may include a primary vent channel opening 503, 513, 523, 533, 543, 553, 563, and 573, respectively that is disposed between a respective cell receptacle and a primary vent channel. With reference to FIG. 6F, the battery housing 500 is shown with an enclosure 602 for a primary vent channel that extends across the primary vent channel openings of the cell receptacles between the external openings at 603 and 604. Additionally, each auxiliary vent channel opening may be associated with a respective auxiliary vent channel. In this regard, the auxiliary vent channel openings 502, 512, 522, 532, 542, 552, 562, and 572 may open into auxiliary vent channels 505, 515, 525, 535, 545, 555, 565, and 575, respectively. The auxiliary vent channels 505, 515, 525, 535, 545, 555, 565, and 575 may be disposed on a top surface 605 of the battery housing 500 and may extend, nonlinearly, to the external openings 504, 514, 524, 534, 544, 554, 564, and 574, respectively.

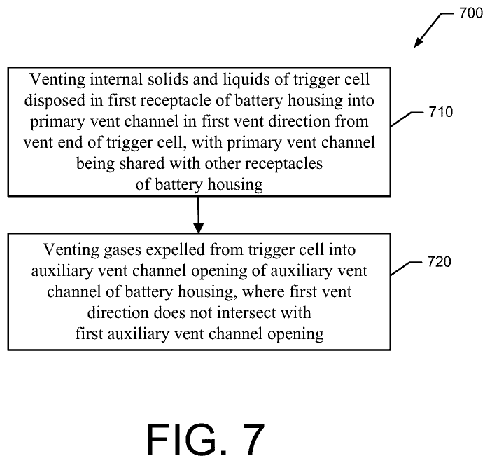

Now with reference to FIG. 7, an example method for venting a cell of a battery is described with respect to flowchart 700. In this regard, according to some example embodiments, at 710, the example method may include venting internal solids and liquids of a trigger cell disposed in a first receptacle of a battery housing into a primary vent channel in a first vent direction from a vent end of the trigger cell. According to some example embodiments, the primary vent channel may be shared with other receptacles for cells of the battery housing. Additionally, according to some example embodiments, at 720, the example method may include venting gases expelled from the trigger cell into an auxiliary vent channel opening of an auxiliary vent channel of the battery housing. In this regard, according to some example embodiments, the first vent direction does not intersect with the first auxiliary vent channel opening. Additionally, according to some example embodiments, venting the gases into the auxiliary vent channel opening may occur in response to the internal solids and liquids of the trigger cell blocking further venting of the trigger cell via the primary vent channel.

Having described some example embodiments of battery housings, the following provides some additional descriptions of some example embodiments of battery housings according to some example embodiments. In this regard, a battery housing may include a plurality of vent channels including a primary vent channel and a plurality of auxiliary vent channels. Each auxiliary vent channel may be isolated from the primary vent channel and other auxiliary vent channels. The battery housing may also include a plurality of receptacles with each receptacle being configured to receive a cell and each receptacle having sidewalls that are configured to operate as barriers to cell venting events occurring in other receptacles. Each receptacle may also include an auxiliary vent channel opening to a respective auxiliary vent channel, and each receptacle may include a primary vent channel opening to the primary vent channel, where each primary vent channel opening is configured to be aligned with a position of a vent valve of a cell disposed within a respective receptacle such that internal substances expelled from the vent valve or a rupture at the vent valve in an associated vent direction are directed into the primary vent channel. Each auxiliary vent channel opening need not be and, in some example embodiments, is not aligned with a respective primary vent channel opening and a respective position of a vent valve.

Additionally, according to some example embodiments, each auxiliary vent channel opening may be positioned in a plane that is substantially orthogonal to a plane of primary vent channel openings. Additionally or alternatively, according to some example embodiments, the primary vent channel and the plurality of auxiliary vent channels may be isolated such that a blockage of the primary vent channel does not inhibit passage of vented gases from a cell installed in a cell receptacle from exiting the battery housing via an auxiliary vent channel. Additionally or alternatively, according to some example embodiments, the sidewalls of each receptacle may extend toward the primary vent channel beyond a position configured to receive a cell in the receptacle to inhibit spreading of ejected gases from the cell into adjacent receptacles. Additionally or alternatively, according to some example embodiments, a primary vent channel wall of the primary vent channel positioned opposite the primary vent channel openings may have a greater mechanical strength than the sidewalls of the receptacles to withstand an impact of solid internal substances ejected from a cell installed in a receptacle. Additionally or alternatively, according to some example embodiments, the battery housing may be formed of materials including a plastic. Additionally or alternatively, according to some example embodiments, the battery housing may be formed of materials including a resin infused plastic that is externally metalized. Additionally or alternatively, according to some example embodiments, the battery housing may be formed of materials including metals, metallic alloys, ceramics, metal-ceramic composites, polymers, or polymer composites. Additionally or alternatively, according to some example embodiments, a plane that passes through the auxiliary vent channels does not intersect with the primary vent channel. Additionally or alternatively, according to some example embodiments, the auxiliary vent channels may be nonlinear.

According to some example embodiments, another battery housing is described. The battery housing may include a primary vent channel, a plurality of auxiliary vent channels, and a plurality of cell receptacles. Each cell receptacle may include a first receptacle and a second receptacle. The first receptacle may be configured to receive a first cell in a first installed position that aligns a first vent direction defined by a first vent valve of the first cell toward the primary vent channel. The second receptacle may be configured to receive a second cell in a second installed position that aligns a second vent direction defined by a second vent valve of the second cell toward the primary vent channel. A first auxiliary vent channel associated with the first receptacle may include a first auxiliary vent channel opening that does not intersect with the first vent direction. A second auxiliary vent channel associated with the second receptacle may include a second auxiliary vent channel opening that does not intersect with the second vent direction.

Additionally, according to some example embodiments, the first auxiliary vent channel opening may be positioned in a plane that is substantially orthogonal to a plane of a primary vent channel opening between the first receptacle and the primary vent channel. Additionally or alternatively, according to some example embodiments, sidewalls of the first receptacle may be configured to operate as barriers to cell venting events occurring in other receptacles. Additionally or alternatively, according to some example embodiments, sidewalls of the first receptacle may extend toward the primary vent channel beyond the first installed position for the first cell to inhibit spreading of ejected gases from the first cell into the second receptacle. Additionally or alternatively, according to some example embodiments, the primary vent channel and the first auxiliary vent channel may be isolated such that a blockage of the primary vent channel does not inhibit passage of vented gases from the first cell from exiting the battery housing via the first auxiliary vent channel. Additionally or alternatively, according to some example embodiments, a primary vent channel wall of the primary vent channel has a greater mechanical strength than sidewalls of the first receptacle to withstand an impact of solid internal substances ejected from the first cell. Additionally or alternatively, according to some example embodiments, the battery housing may be formed of materials including plastics, metals, metallic alloys, ceramics, metal-ceramic composites, polymers, or polymer composites. Additionally or alternatively, according to some example embodiments, a plane that passes through the first auxiliary vent channel does not intersect with the primary vent channel. Additionally or alternatively, according to some example embodiments, the first auxiliary vent channel may be nonlinear.

Many modifications and other example embodiments in addition to those set forth herein will come to mind to one skilled in the art to which these embodiments pertain having the benefit of the teachings presented in the foregoing descriptions and the associated drawings. Therefore, it is to be understood that the embodiments are not to be limited to those disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A battery housing comprising:
a plurality of vent channels comprising a primary vent channel and a plurality of auxiliary vent channels, each auxiliary vent channel of the plurality of auxiliary vent channels being isolated from the primary vent channel and other auxiliary vent channels; and
a plurality of receptacles, each receptacle of the plurality of receptacles being configured to receive a cell, each receptacle having sidewalls that are configured to operate as barriers to cell venting events occurring in other receptacles;
wherein each receptacle comprises an auxiliary vent channel opening to a respective auxiliary vent channel;
wherein each receptacle comprises a primary vent channel opening to the primary vent channel, each primary vent channel opening being configured to be aligned with a position of a vent valve of a cell disposed within a respective receptacle such that internal substances expelled from the vent valve or a rupture at the vent valve in an associated vent direction are directed into the primary vent channel;
wherein each auxiliary vent channel opening is not aligned with a respective primary vent channel opening and a respective position of a vent valve.

2. The battery housing of claim 1, wherein each auxiliary vent channel opening is positioned in a plane that is substantially orthogonal to a plane of primary vent channel openings.

3. The battery housing of claim 1, wherein the primary vent channel and the plurality of auxiliary vent channels are isolated such that a blockage of the primary vent channel does not inhibit passage of vented gases from a cell installed in a cell receptacle from exiting the battery housing via an auxiliary vent channel.

4. The battery housing of claim 1, wherein the sidewalls of each receptacle extend toward the primary vent channel beyond a position configured to receive a cell in the receptacle to inhibit spreading of ejected gases from the cell into adjacent receptacles.

5. The battery housing of claim 1, wherein a primary vent channel wall of the primary vent channel positioned opposite the primary vent channel openings has a greater mechanical strength than the sidewalls of the receptacles to withstand an impact of solid internal substances ejected from a cell installed in a receptacle.

6. The battery housing of claim 1, wherein the battery housing is formed of materials comprising a plastic.

7. The battery housing of claim 1, wherein the battery housing is formed of materials comprising a resin infused plastic that is externally metalized.

8. The battery housing of claim 1, wherein the battery housing is formed of materials comprising metals, metallic alloys, ceramics, metal-ceramic composites, polymers, or polymer composites.

9. The battery housing of claim 1, wherein a plane that passes through the auxiliary vent channels does not intersect with the primary vent channel.

10. The battery housing of claim 1, wherein the auxiliary vent channels are nonlinear.

11. A battery housing comprising:
a primary vent channel;
a plurality of auxiliary vent channels; and
a plurality of receptacles comprising a first receptacle and a second receptacle, the first receptacle being configured to receive a first cell in a first installed position that aligns a first vent direction defined by a first vent valve of the first cell toward the primary vent channel, the second receptacle being configured to receive a second cell in a second installed position that aligns a second vent direction defined by a second vent valve of the second cell toward the primary vent channel;
wherein a first auxiliary vent channel associated with the first receptacle comprises a first auxiliary vent channel opening that does not intersect with the first vent direction;
wherein a second auxiliary vent channel associated with the second receptacle comprises a second auxiliary vent channel opening that does not intersect with the second vent direction.

12. The battery housing of claim 11, wherein the first auxiliary vent channel opening is positioned in a plane that is substantially orthogonal to a plane of a primary vent channel opening between the first receptacle and the primary vent channel.

13. The battery housing of claim 11, wherein sidewalls of the first receptacle are configured to operate as barriers to cell venting events occurring in other receptacles.

14. The battery housing of claim 11, wherein sidewalls of the first receptacle extend toward the primary vent channel beyond the first installed position for the first cell to inhibit spreading of ejected gases from the first cell into the second receptacle.

15. The battery housing of claim 11, wherein the primary vent channel and the first auxiliary vent channel are isolated such that a blockage of the primary vent channel does not inhibit passage of vented gases from the first cell from exiting the battery housing via the first auxiliary vent channel.

16. The battery housing of claim 11, wherein a primary vent channel wall of the primary vent channel has a greater mechanical strength than sidewalls of the first receptacle to withstand an impact of solid internal substances ejected from the first cell.

17. The battery housing of claim 11, wherein the battery housing is formed of materials comprising plastics, metals, metallic alloys, ceramics, metal-ceramic composites, polymers, or polymer composites.

18. The battery housing of claim 11, wherein a plane that passes through the first auxiliary vent channel does not intersect with the primary vent channel.

19. The battery housing of claim 11, wherein the first auxiliary vent channel is nonlinear.

20. A method for venting a cell within a battery housing, the method comprising:
venting internal solids and liquids of a trigger cell disposed in a first receptacle of the battery housing into a primary vent channel in a first vent direction from a vent valve of the trigger cell, the primary vent channel being shared with other receptacles for cells of the battery housing; and
venting gases expelled from the trigger cell into an auxiliary vent channel opening of an auxiliary vent channel of the battery housing, wherein the first vent direction does not intersect with the auxiliary vent channel opening.
